(19) United States
(12) Patent Application Publication
(10) Pub. No.: US 2007/0226231 A1
(43) Pub. Date: Sep. 27, 2007

(54) Systems and methods for managing business issues

(76) Inventor: G. Venkat, Lombard, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/371,735

(22) Filed: Mar. 9, 2006

(51) Int. Cl. G06F 7/00

(52) U.S. Cl. 707/100

(57) ABSTRACT

Methods, systems, and articles of manufacture consistent with the present invention manage business issues by modeling the business issues and domain semantics in real time. After the business issues are modeled, the functional and the underlying technical and infrastructure components that are responsible for fulfilling the business process execution are located and identified automatically. Specific behaviors of those components are observed to determine what transpires within those components so that the information can be related back to the business issues. Accordingly, business issues may be analyzed in real-time with current data that is automatically extracted from the underlying hardware and software systems.

### FIELD OF THE INVENTION

The present invention relates to computer-implemented modeling, and in particular, to managing business issues using computer-implemented modeling.

### BACKGROUND OF THE INVENTION

Businesses are often faced with complex issues that are difficult to overcome. An issue may be rooted in the business processes, and therefore may be affected by many factors that are difficult to observe. The issues are made further complex when the business uses computer systems to operate. For example, hardware and software components of the computer system may be incompatible or may not provide the type of data that is needed to address the business issue.

One approach that has been used to address business issues has been to model the business domain. The domain may be limited to a particular process (e.g., tracking inventory) or may include multiple processes for a business enterprise. Using this conventional approach, a model is created and applied to historical data to determine cause and effect. The business process execution language (“BPEL”) has been used in this conventional approach. BPEL may be used to define a business process as a workflow of steps. However, this approach does not address business issues in real time and fails to consider current data. Further, this known approach does not address problems that may exist in a business's underlying computer systems.

FIG. 1 depicts the architectural layers 100 of a business enterprise. The layers include the enterprise's business architecture 101, functional architecture 103, technical architecture 105, and infrastructure architecture 107. Business architecture 101 relates to business process orchestration. Business process characteristics are defined and exist in this layer. Business issues manifest themselves in this layer and may be visible to someone involved in the daily aspects of a business. The business processes are specific and unique to an enterprise. Even if two companies are in the same business, e.g., retail stores, the business processes are vastly different. The business issues that arise subsequently are also varying in nature.

Functional architecture 103 includes the packaged and custom software applications as well as the information model relevant to the business domain. The execution of the business processes may be embodied in packaged application software like ERP systems, warehouse systems, or custom developed applications. This architectural layer may be thought of as a functional layer that supports the orchestration of the business processes.

The functional architecture layer is in turn supported by technical architecture 105. The technical architecture includes technology components such as application servers, content and document management systems, web servers, operating systems, and the like. The technology components are themselves deployed on infrastructure architecture 107, which includes hardware such as servers, networks, and routers.

There is a need to model business issues and relevant domain semantics in real time to be able to make effective business decisions. Further, conventional methods fail to bridge the business architecture and functional architecture with a visual and canonical representation and fail to automatically discover and wire the technical components into the functionality and business issues.

### SUMMARY OF THE INVENTION

Methods, systems, and articles of manufacture consistent with the present invention manage business issues by modeling the business issues and domain semantics in real time. After the business issues are modelled, the functional and the underlying technical components that are responsible for fulfilling the business process execution are located and identified automatically. Specific behaviours of those components are intercepted to determine what transpires within those components so that the information can be related back to the business issues.

In accordance with articles of manufacture consistent with the present invention, a computer-implemented method in a data processing system having a program for creating a business domain model. The method comprises the steps of: identifying an observation that influences a business issue; identifying an event that corresponds to the observation; implementing a rule that may generate an output responsive to the event; and applying the rule to the event.

In accordance with articles of manufacture consistent with the present invention, a computer-readable medium containing instructions that cause a program to perform a computer-implemented method for creating a business domain model is provided. The method comprises the steps of: identifying an observation that influences a business issue; identifying an event that corresponds to the observation; implementing a rule that may generate an output responsive to the event; and applying the rule to the event.

In accordance with systems consistent with the present invention, a data processing system is provided. The data processing system comprises: a memory having a computer-implemented program performs a method for creating a business domain model that identifies an observation that influences a business issue, identifies an event that corresponds to the observation, implements a rule that may generate an output responsive to the event, and applies the rule to the event; and a processing unit that runs the program.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 shows the architectural layers of an enterprise;

FIG. 2 shows how the architecture layers of an enterprise can be made to work together by providing a business domain model and a hotwiring model in accordance with the present invention;

FIG. 3 is a block diagram of an illustrative data processing system suitable for use with the present invention;

FIG. 4 is a block diagram of an illustrative host system suitable for use with the present invention;

FIG. 5 is a block diagram that depicts illustrative components of the platform system;

FIG. 6 is a functional block diagram that shows illustrative steps for managing business issues in accordance with the present invention;

FIG. 7 depicts a block diagram of an illustrative kernel;

FIG. 8 is an illustrative screen shot of the business domain modeling user interface;

FIG. 9 is a functional block diagram showing illustrative steps for deploying a business domain model;

FIG. 10 is an illustrative screen shot that depicts the discovered components;

FIG. 11 shows an illustrative screen shot of mapping data points to model parameters;

FIG. 12 shows a block diagram of components relating to managing business issues in accordance with the present invention;

FIG. 13 is a sequence diagram that depicts illustrative steps for deploying an agent;

FIG. 14 is a sequence diagram that depicts illustrative steps for the mastering and control component;

FIG. 15 is a functional block diagram that shows illustrative components for event processing and rule processing;

FIG. 16 shows illustrative components of an event processor;

FIG. 17 shows the communication of data streams to components outside the event processor;

FIG. 18 depicts illustrative components of an event manager; and

FIG. 19 depicts illustrative components of a rule engine manager.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention manage business issues by modeling the business issues and domain semantics in real time. After the business issues are modelled, the functional and the underlying technical components that are responsible for fulfilling the business process execution are located and identified automatically. Specific behaviours of those components are intercepted to determine what transpires within those components so that the information can be related back to the business issues.

In an illustrative example, a retail supply chain has multiple links in the chain and multiple participants, such as the manufacturer, the plant, the wholesaler, the retailer, transportation and logistics provider, and the consumer. The manufacturer wants to reduce its inventory by identifying which of its products are selling at the retailers and in what quantities. Accordingly, the manufacturer creates a business domain model to assist with his analysis. To create the business model, the manufacturer identifies observations that influence the business issue. These observations include, for example, product SKU numbers, store location, quantity purchased, shelf level, reorder quantity, and inventory level. Further, the manufacturer identifies events that correspond to the observations. The illustrative events include an order being filled, an order being delayed, and an inventory falling below a reorder level. Then, the manufacturer implements one or more rules that receive the events as inputs and generate outputs responsive to the events. An illustrative rule determines whether an order was filled completely or partially. Another illustrative rule determines whether the order was filled on time or with a delay.

In order to make observations in real time or to change which observations are being made, the manufacturer needs to observe what is happening in the lower architecture layers that support the supply chain process orchestration. For example, observations may come in real time from functional systems, such as ERP systems, order fulfillment system, warehouse management systems, and fleet management systems. The relevant observations are correlated and aggregated. These observations result in events that could display influences on the business issue by providing visibility into fill rates, response delays, and response frequencies in real time.

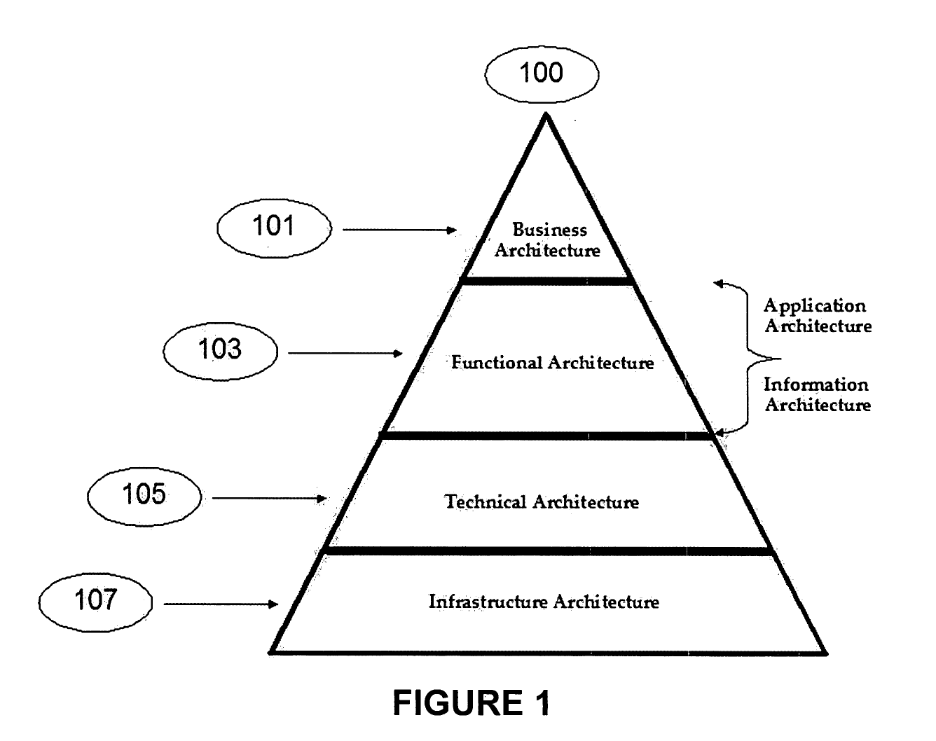

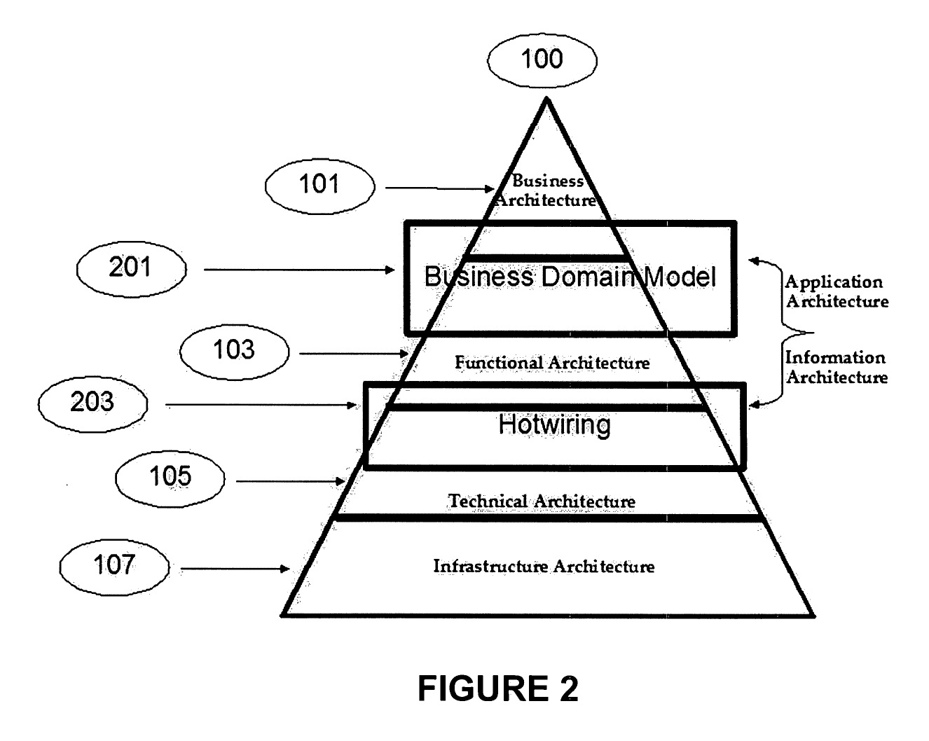

FIG. 2 depicts how the architecture layers of an enterprise can be made to work together by providing a business domain model and a hotwiring model in accordance with the present invention. In FIG. 2, the architecture layers from FIG. 1 are shown with the addition of two models. Methods, systems, and articles of manufacture consistent with the present invention define and capture business issues in the form of a model, which is referred to herein as a business domain model 201 (“model.”) The act of creating a business domain model is referred to herein as business domain modeling. As will be described in more detail below, a business domain modeler component provides a software environment in which one may create the model visually through drag and drop interfaces. Unlike conventional approaches, methods, systems, and articles of manufacture consistent with the present invention relate the business issues to the functional and technical architecture layers.

After the model is created and deployed, one or more agents may be used to identify and connect with components in the functional and technical layers so that information that is required as input for the model can be captured. This technique is referred to herein as “hotwiring” 203 and may be represented as a visual and canonical representation as well. A hotwiring studio program may be used to identify the respective components of the functional and technical architecture layers to the agents. The hotwiring studio, as an illustrative example, may show the discovered components along with their system attributes, business attributes, and statistics that these components support. Collectively, this represents the behaviour of the component. This is further unlike conventional approaches, which fail to bridge the process and functionality with a visual and canonical representation as well as automatically discover and wire the technical components into the functionality and business issues.

The hotwiring studio also shows the domain model that was created that captures the business issues. In an illustrative example, a user may simply drag and drop which specific attribute is necessary to gain visibility, on to the domain model. The system platform will automatically start collecting observations as the processes orchestrate and then, through the defined business domain model, the system platform will proceed to create and aggregate the relevant metrics and events and further aggregate the events for consumption by other systems or by human beings. Business rules can also be defined and attached to the events so that upon meeting specific and relevant conditions, business rules are fired and could have other consequences. Reports are also provided to enable businesses to make decisions that can impact them in real-time since the system platform executes and collects the observations in real-time.

The concept of collecting observations from underlying components (e.g., from the functional, technical, and infrastructure architecture layers), via hotwiring or otherwise received, and then aggregating those observations in conformance to a pre-defined business domain model of interest is referred to herein as “business event processing.” The underlying observations may be obtained from varying locations, sources, and times. The aggregated observations are referred to herein as “business events.” The business domain modeling and business event processing collectively provide enterprises with the ability to make business decisions that were until now not possible since neither the business issues could be modelled in a visual form nor could observations be made into the execution of processes by attaching to the underlying components at their behaviour level and capture information at that level.

An analogy that can be derived is that for networks and hardware, via SNMP, conventional approaches capture what is going on at the hardware level to indicate hardware failure or when an interesting event happens within the infrastructure. Methods, systems, and articles of manufacture consistent with the present invention bring such capabilities to all layers of an enterprise and also allow such observations to be interpreted in the business context to solve business issues.

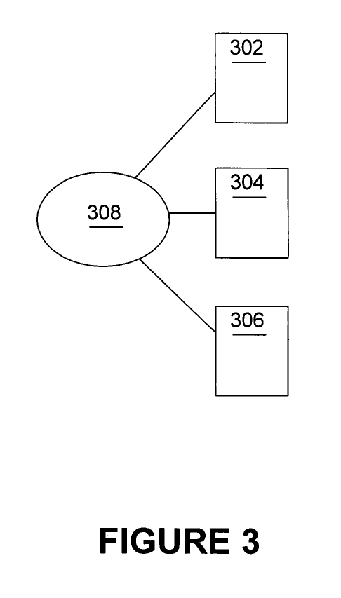

FIG. 3 depicts a block diagram of a data processing system 300 suitable for use with methods, systems, and articles of manufacture consistent with the present invention. Data processing system 300 is also referred to herein as “the system.” The system includes one or more infrastructure components 302, 304, and 306, which may be components in the infrastructure architecture. Infrastructure component 302 is a host system, which is described in more detail below. The other infrastructure components may be, for example, servers or other types of devices. The infrastructure components may communicate via a network 308. The network is a network suitable for use with methods and systems consistent with the present invention, such as a local area network or wide area network. In the illustrative embodiment, the network is the Internet. Further, the network may be a wired or a wireless network. The system may comprise, for example, hundreds of product offerings from multiple vendors. Further, the system may include a multitude of hardware and software systems, custom applications, and packaged applications that support the business processes.

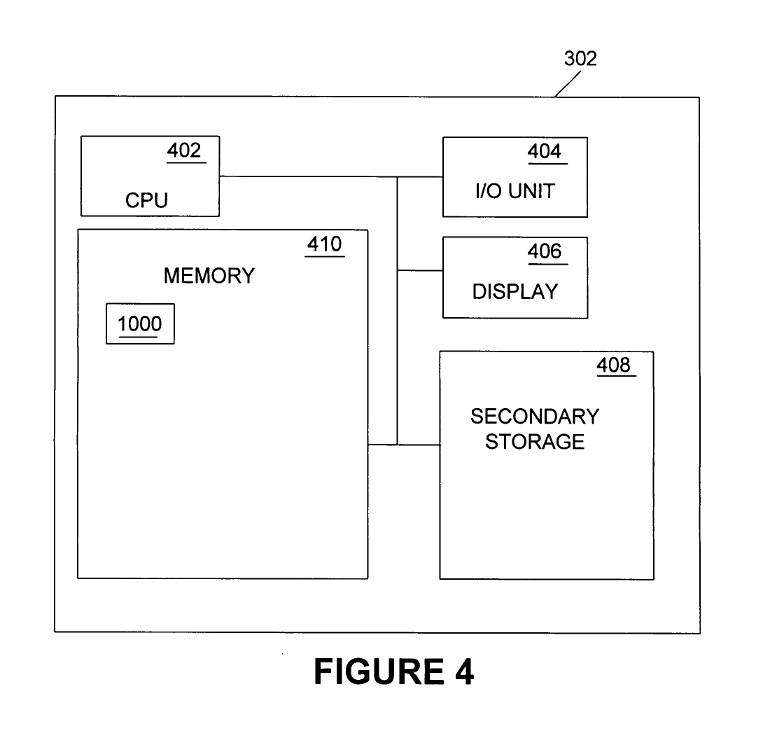

FIG. 4 depicts a more detailed view of host system 302. The system may comprise multiple components each of which is capable of executing on its own on an underlying hardware system. The components that make up the host system can run on the same hardware or can be distributed to run on various pieces of hardware. The hardware can be any suitable system, such as for example mainframes, AS400s, Intel or AMD-based hardware, embedded systems, and micro-controllers. The hardware can be in a networked state or in a non-networked state, i.e. connected or disconnected mode. Further, the hardware and the operating system may be in a virtualized state where one hardware may be running multiple operating systems.

The illustrative host system is deployed in the form of a router. The host system router is hardware that is optimized much in the same fashion as a router that routes IP packets. The host system routes business event packets. The host system may be, for example, an IBM-compatible system running the Linux, UNIX, or Windows operating systems. One having skill in the art will appreciate that hardware and programs other than those described in the illustrative examples can be implemented. IBM, Linux, UNIX, Microsoft, and Windows, are trademarks or registered trademarks of their respective owners. Other names used herein are the property of their respective owners.

The illustrative host system comprises a central processing unit (CPU) 402, an input/output (I/O) unit 404, a display device 406, a secondary storage device 408, and a memory 410. The host system may further comprise standard input devices such as a keyboard, a mouse or a speech processing means (each not illustrated). Memory 410 may comprise one or more software components 500 as described below.

One of skill in the art will appreciate that each program and module described herein can be a stand-alone program and can reside in memory on a data processing system other than the described system. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with described system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the system have been described, one skilled in the art will appreciate that a data processing system suitable for use with methods, systems, and articles of manufacture consistent with the present invention may contain additional or different components.

One having skill in the art will appreciate that the host system and other infrastructure components can themselves also be implemented as client-server data processing systems. In that case, a program or module can be stored on, for example, the host system as a client, while some or all of the steps of the processing of the program or module described below can be carried out on a remote server, which is accessed by the host system over the network. The remote server can comprise components similar to those described above with respect to the host system, such as a CPU, an I/O, a memory, a secondary storage, and a display device.

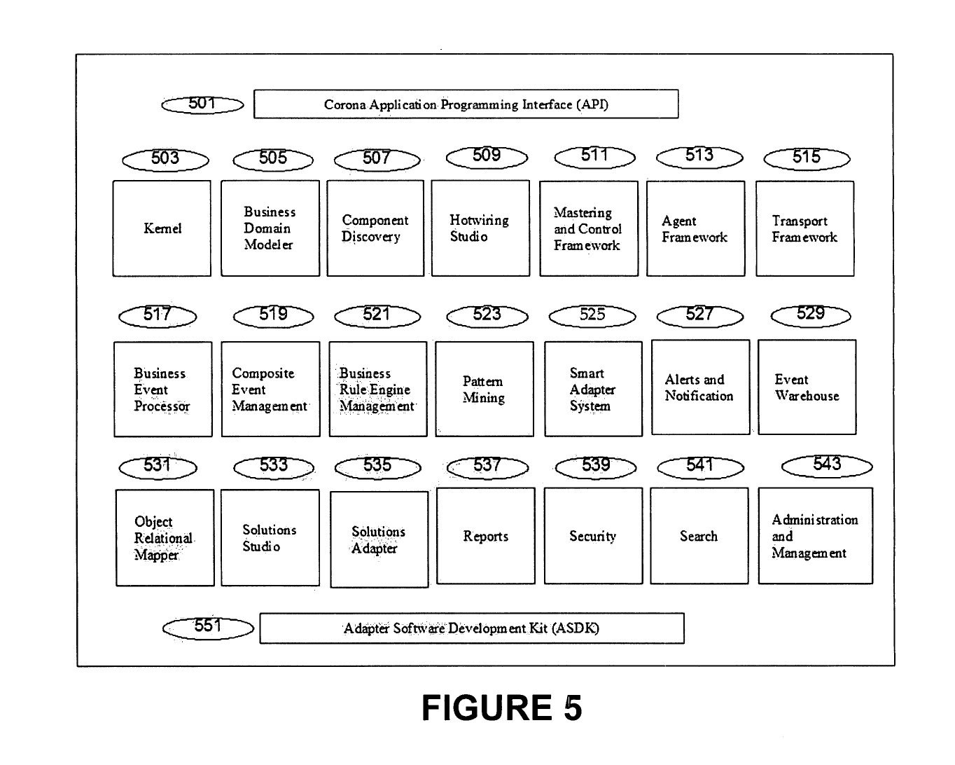

FIG. 5 depicts in more detail the system's software components 500, which may reside in the host system's memory. In the illustrative example, the group of software components are referred to as the “system platform,” however, one having skill in the art will appreciate that “system platform” is an illustrative name and that the software components may be referred to using a different moniker.

The system platform comprises a set of core services forming the base environment in which the system operates and provides product functionality to the customer. The system platform components are first briefly described below and then discussed in more detail. The system platform's components may be distinct entities rather than functions within a monolithic application and may be distributed across multiple physical systems with communications automatically routed between components.

In the illustrative example, the kernel 503 may comprise multiple sub-components and is explained in more detail below. The kernel may be the first component that is started. The kernel starts up and deploys core services like a deployer and server components. Then, a service configurator component deploys other services. Services are made available via registries.

The business issues are modeled using the business domain modeler 505. The output of the modeling captures the relationships between observations that need to be made within the enterprise at the levels of the functional, technical and infrastructure architecture that cause the issues to manifest themselves in the business architecture layer. During the process of preparing the business domain model, one may not be required to look to the functional, technical, and infrastructure architecture layers. Instead, the business domain model may be prepared using information that relates to the business architecture layer without information from the other layers.

The component discovery system 507 allows agents that are deployed on various architecture layers along with packaged applications, custom application, other technical components or infrastructure components, to discover the other components that are executing on the system. If components are added or deleted, the component discovery system is aware of that in real-time. In addition to discovering components, the component discovery system also discovers specific business attributes, system attributes, and statistics.

The components that are discovered by component discovery system 507 are made available to a hotwire studio 509. Projects created and published by 505 are also made available to the hotwire studio. The hotwire studio allows observations that are of interest to a business issue modeled can be mapped to a specific behavior (attribute) of the components that were discovered by component discovery system 507.

A mastering and control framework 511 comprises several components. This subsystem is used to control agents that have been deployed, ensure that the agents are started, stopped and controlled, ensure that agents provide information on components that they discover, ensure that hotwire studio 509 has the latest list of components discovered, ensures that the components and behaviors that need to be hotwired are conveyed to the agent via a hotmap, and ensures that an agent also sends its discovered components via multiple formats to internal and external systems that may be interested in the discovered components.

An agent framework 513 allows third-parties to build and deploy agents.

A transport framework 515 allows a component to communicate with another component, each of which could be internal or external to the system, independent of transport protocols, transport formats, message formats, wire formats, and configurations.

A business event processor 517 is an engine that allows observations and information from a system or enterprise to be correlated in space and time (causal analysis) to build a related set of information that is used to build upon one another further to enable creation of business events. In the illustrative example, this is a multi-stage engine that can piece together high-level information and relate to business issues from seemingly unrelated sets of observations.

Another component is the composite even management 519 that provides management of metrics and events to form aggregated entities called business events, which are pieced together from atomic data items that occur at various points in space and time.

Business rule engine management 521 applies business rules to occurring business events. If an event meets a certain rule, it enables a consequence to happen as a further result of an event meeting a specific condition.

As events are amassed over time, pattern mining 523 detects patterns in historically collected business events. Patterns can be discovered based on either an external stimulus or by the system arbitrarily by artificial intelligence

Smart adapter system 525 allows the system to communicate with external enterprise systems, databases, information systems, agents, data streams and other streams of information or information repositories and also translates the information from one format to another if required.

The alerts and notifications component 527 is responsible for contacting and conveying information between various components. These components can be internal or external to the system. The information conveyed can be in any format and can be conveyed on any transport mechanism including, for example, email, object messages, asynchronous and synchronous messages.

Event warehouse 529 keeps historical track of occurring observations and aggregated events.

Object relational mapper 531 allows objects (including metrics and events) to be translated to a relational database format.

Solutions studio 533 enables one to visually build maps between objects and relational tables. These relational tables themselves may be relevant to a vertical industry, such as retail.

Solutions adapter 535 converts occurring metrics and events according to a map created by object relational mapper 531 using solutions studio 533, into an industry-specific solution that targets business issues, such as in retail.

The reports and dashboards component 537 comprises decision making tools that can be conveyed in real-time or later, in multiple formats including charts, graphs and other visual objects. For example, information may be presented in one or more formats, such as a PDF format, HTML format, as a spreadsheet, as a word processing document, and the like. The information may be displayed, for example, on a display device such as a computer screen, PDA, and the like. Further, the information may be sent via email, fax, or other communication mechanism. The information may also be presented in an interactive format, such that a user may interact with the presented information.

A security component 539 provides ability for authentication, authorization and secure transfer of information within the system and between the platform system and external systems.

Search component 541 enables searching for information captured by the system, with relevant context including user created documents or models.

Administration and management component 543 provides for administration and management of the platform system.

An application programming interface (API) 501 provides ability for an external party to add new services or components to the system or extend the functionality of the existing components.

Adapter Software Development Kit (ASDK) 551 enables one to provide new adapters that will allow the system to communicate with existing or future systems as well as translate data from one format to another.

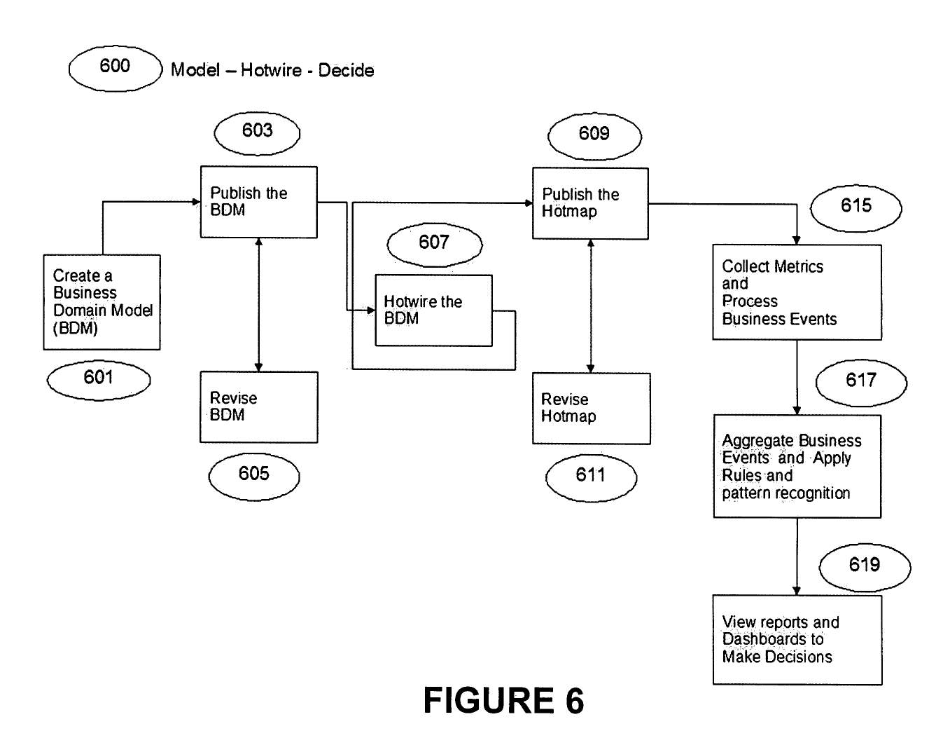

FIG. 6 shows a flow diagram depicting illustrative steps for managing business issues including modeling, hotwiring, and decision making. To allow businesses to make real-time decisions as well as to allow businesses to discover patterns in collected business events, a business domain model is created to capture business issues of interest (step 601). Then, the business domain model is published to the system (step 603). This may involve making the model available for use on the system. For example, the model may be automatically deployed onto the system or the model may be manually copied onto the system and deployed. The business domain model may be revised even after it has been published (step 605).

When the business domain model is published, agents are deployed to discover relevant components from the functional and technical architecture layers and to report their discoveries. Components may also be discovered without the use of agents, for example, via data entry by a user.

After publishing the business domain model and discovering components, a hotwiring model is implemented (step 607). The hotwiring model connects the business domain model to the discovered components and to specific behavior within the discovered components. The hotwiring model is then published (step 609). This may involve making the model available for use by an agent that is controlled by the system. Even after the hotwiring model has been published, it may be modified (step 611). For example, an administrator revise the hotwiring model to collect additional discovered components for the business domain model. When the hotwiring model is published, specified components are monitored by agents and behavioral data is passed back through the system.

The observations are collected and processed into business events, going through the relevant stages, to conform to the published business domain model (step 615). Then, the system aggregates and operates upon the collected business events and ensures that the business events are made available to other systems on demand and are stored for historical purposes (step 617). The system or a user of the system may then generate reports and dashboards with which to make decisions (step 619). Since the system operates in real-time, any part of the system may be modified in real-time to keep the system current to the changing business issues and business landscape.

Each of the steps of FIG. 6 and the components that perform the various steps will be described in more detail below.

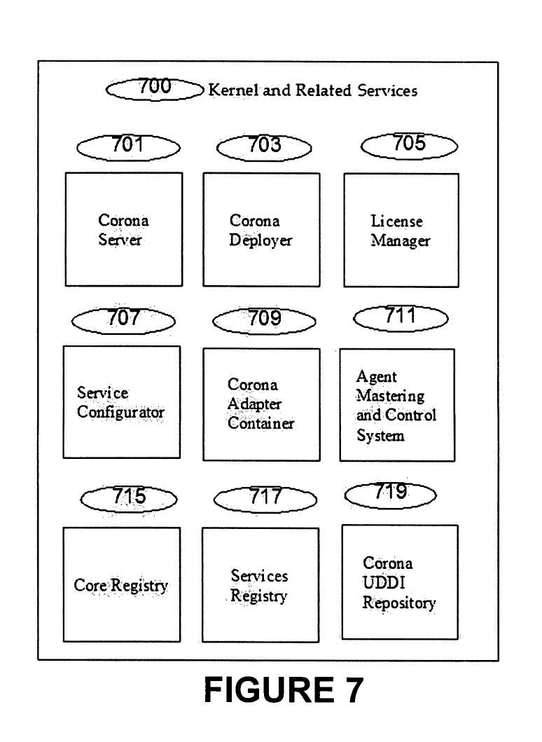

FIG. 7 is a block diagram that depicts components of the kernel 700 in more detail. The kernel may be the first component that is deployed in the system platform. As shown in FIG. 7, the illustrative kernel includes a system platform server 701, a system platform deployer 703, a license manager 705, a service configurator 707, a system platform adapter container 709, an agent mastering and control system 711, a core registry 715, a services registry 717, and a system platform UDDI repository 719. Each of these components of the kernel is described in more detail below.

In the illustrative example, the system platform deployer is deployed first when the kernel is deployed on an application server. Next, the system platform server service (“server”) of the kernel is deployed. The server creates an instance of the license manager and validates that this server is licensed to run on the respective hardware. If license is missing or not valid, the server is not allowed to continue startup. The server creates the service configurator, which reads in the kernel service and service configuration files and creates service configuration objects for each. The service configurator also sorts the objects into an order to handle dependencies between the services. The sorted list is returned to the server.

The server then starts the rest of the kernel services and the regular services. The core registry service is started to track kernel services. The service registry service is started to track regular server services. The adapter container service is started and in turn creates several components: an adapter registry for tracking adapters, an object for creating instances of adapters, an object for creating instances of third party adapters, a resource manager that manages the types of adapters permitted, and default adapter instances as defined in the adapter container's configuration file.

The server also starts the web services repository, which may be for example a universal description discovery and integration (UDDI) repository or WS-Discovery repository. The server also starts the agent master service, and the component discovery manager service, and the hotwire router service. Each of these components are described in more detail below.

Functional units of the platform system are deployed to the server as services. Each service may be implemented as a management (e.g., MBean) interface specified by the server. The interface provides for the following capabilities:
Life-cycle control via methods to start/stop the service.
Notification mechanism to alert the service of a change of state of another component and/or to allow the service to send notifications to other components.
Registry addition/removal methods for keeping the appropriate registry up-to-date.

In the illustrative example, services are hot-deployable to the server and do not require a restart of the entire environment to be put in production. In order to be deployable to the server, services may be encapsulated within archive files.

The server provides deployed services with context and configuration information. Context is information about the environment in which the service has been deployed. In particular, information about the server itself is provided to services so that they can communicate with other components and gather further information from the server. Configuration information provided by the server is specific to the service itself.

The system platform deployer deploys system platform services. On startup, the deployer begins watching the system platform service deployment directory for the appearance of new services. When a new service is found, the deployer determines whether the service has a proper service configuration file and is in the form of a platform system archive. The deployer also communicates with the license manager to confirm that the service is licensed to run on this platform installation. Once the service has passed these tests, it is deployed to the platform and started. The new service is registered with the platform and the deployer sends notifications to interested parties regarding the state of the new service. In the illustrative example, the deployer activates the server component as part of its initialization sequence.

The server creates and activates the following core components:
Core registry
Service registry
Adapter container

Each of these components is in itself a system platform service and as a result is accessible through an administrative management console user interface.

The core registry is a registry database within the server that maintains a list of core components currently deployed to the server. The service registry is a registry database within the server that maintains a list of (non-core) services currently deployed to the server.

The adapter container creates and manages adapters. The adapter container uses configuration information to instantiate both agent-provisioning adapters and data-transformation adapters. Communications between the server and agents including hotwiring specifications are routed by the adapter container via the appropriate adapters or other services.

An event bus provides a message routing and transport system for exchange of information between components. The event bus may comprise multiple message bus (MOM) implementations. In the illustrative example, the default configuration for the event bus is to utilize an enterprise's existing enterprise service bus (ESB) for high-volume atomic metric data flow from agents to the server while providing a separate event bus for internal communications including command and control messages between components. The components that rely on the event bus for message routing may be implemented so that the implementation of the underlying MOM can be replaced with a new version or product without requiring a rebuild of the components themselves.

The platform system is built upon an underlying application server. The application server provides basic functionality including the ability to deploy services and applications, manageability of components via a management (e.g., JMX, WMI) interface, pooling of often-used resources and communication/notifications between components. In the illustrative example, the specifics of the application server may be hidden from the point of view of users. The platform system components may be implemented in such a fashion that the application server could be replaced with a different version or product without requiring significant modification of the core components themselves.

The business domain modeler provides a user interface for users to create projects that may comprise the following illustrative elements:
Atomic Metric: Basic unit of information which cannot be sub-divided further. This is an observation of interest to a particular business domain.

Example: SKU number of a product
Group Metric: One or more atomic metrics are combined to form a single group metric.

Example: Product Detail which includes SKU number, Product Serial Number, Product Description, Item ID
Simple Event: Simple event contains one or more atomic metric(s) and one or more group metric(s).

Example: Product Sale Event which includes Product Detail and Store Detail group metrics
Composite Event: Composite event contains one or more simple events and one or more composite events along with none, one or more business rules applied for any of the simple events.

Example: Inventory Reorder Event
Derived Metrics: Computed value from the occurring atomic metrics.
Business Rule: When an event occurs, a set of conditions that can be verified against the event to take a suitable course of action.

Example: When inventory level falls below an established reorder level for a particular product, please order some more merchandise.
Query: External stimulus to a knowledge base to make an inference based on historical information.
Knowledge Base: A database of events that together constitute a meaningful relationship to make the events useful in various contexts.
Report Design Template: A template that can be used to generate reports by users so that summary of information or knowledge can be seen in pictorial, tabular or other form and used as an aid in decision making.

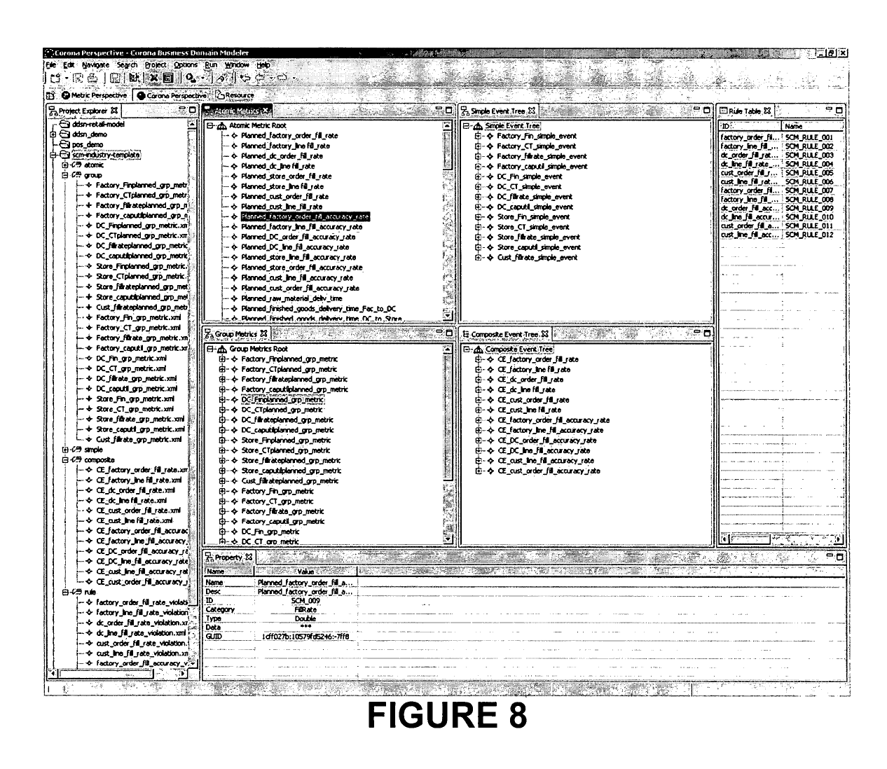

FIG. 8 is an illustrative screen shot of the graphical user interface presented by the business domain modeler. Each of these illustrative user-interface elements are shown in FIG. 8.

The business domain model represents the processes, process characteristics, business metrics, information architecture and domain specific functionality pertaining to a specific line of business, vertical industry or horizontal industry segment. The business analysts and domain experts associated with a line of business have expertise and a sound understanding of their business process flows.

At the other end of the spectrum are the applications and components that execute in order to realize the business process and thus enable a business domain. Inside these applications and components is where the data and information flows while conceptually everyone looks at the process execution.

Methods, systems, and articles of manufacture consistent with the present invention represent business issues via a business domain model by defining business metrics, aggregating business metrics into simple events, aggregating simple events into composite events and further into higher-level composite events. The business domain modeler allows an enterprise to define an event of interest inside a business process. Such events can also be aggregated to form higher-level composite events. This event model is in turn made up of metrics. This model can be visually captured and stored. Business rules can also be applied to the model.

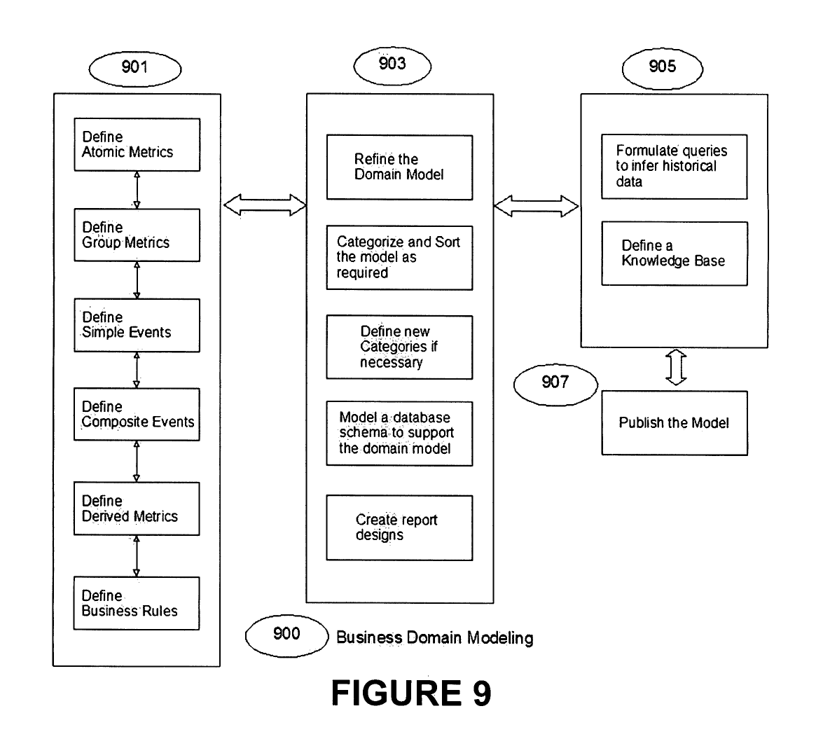

FIG. 9 is a functional block diagram of the business domain modeler. First, the business domain modeler receives user input to define business metrics (observations), also called atomic metrics, that the enterprise is interested in seeing in its business process (step 901). The metric defined may have, for example, a name, id, type, category, description and the like. The defined metrics can be aggregated to form group metrics and group metrics can further be aggregated with other group and atomic metrics to form nested group metrics.

Group metrics are aggregated into simple events. Simple events represent a business event of interest that occurs within a business process. The business event is made up of “observations” called metrics in a group metrics form. There can be any number of group metrics in a simple business event. The observations can themselves come from any source and could have occurred at any time. The business event enables a relationship to be formed among the occurring observations. The simple events in turn can be aggregated to form composite events. Composite business events can be further aggregated with other simple and composite metrics to form nested composite events.

Observations, or business metrics, can be operated upon. For example, one can add subtract, take ratios, multiple or do some custom operation upon a group of observations. After performing operations upon a group of metrics, the resultant quantity is referred to herein as a derived metric.

The user can further define business rules that may be attached to business events. Business rules can, for example, compare observations, derived metrics or match a condition upon the occurrence of a business event. If the condition is met, alerts and notifications can be generated and sent to another system that is interested. Also, conditions can have one or more consequences associated thereto. The consequence can also be defined as an action that happens within the system or within an external system.

In step 903, the user can further refine the domain model and categorize and sort the model as may be necessary. The user may further define new categories and model a database schema to support the model. Reports may be designed that will be populated upon publishing of the model and collection of business events over time.

In step 905, the user may formulate queries that can be posed to business events that are eventually collected upon publishing of the model. Collected business events can be related together and loaded into a knowledge base against which formulated queries can be executed against.

The illustrative objects defined in the above steps may be presented in a visual representation, can be dragged and dropped, sorted, categorized, re-used, re-purposed, shared, versioned, and the like. These objects that are defined may be stored, for example, in an xml schema, or in another data format and may also be written to a database. Further, they may be grouped into a project.

Projects that are published can be made alive by hotwiring them with components and associated behaviors (step 907). Live projects can be replaced in real-time without interrupting operation of the system. Live projects can also be archived, updated, or deleted.

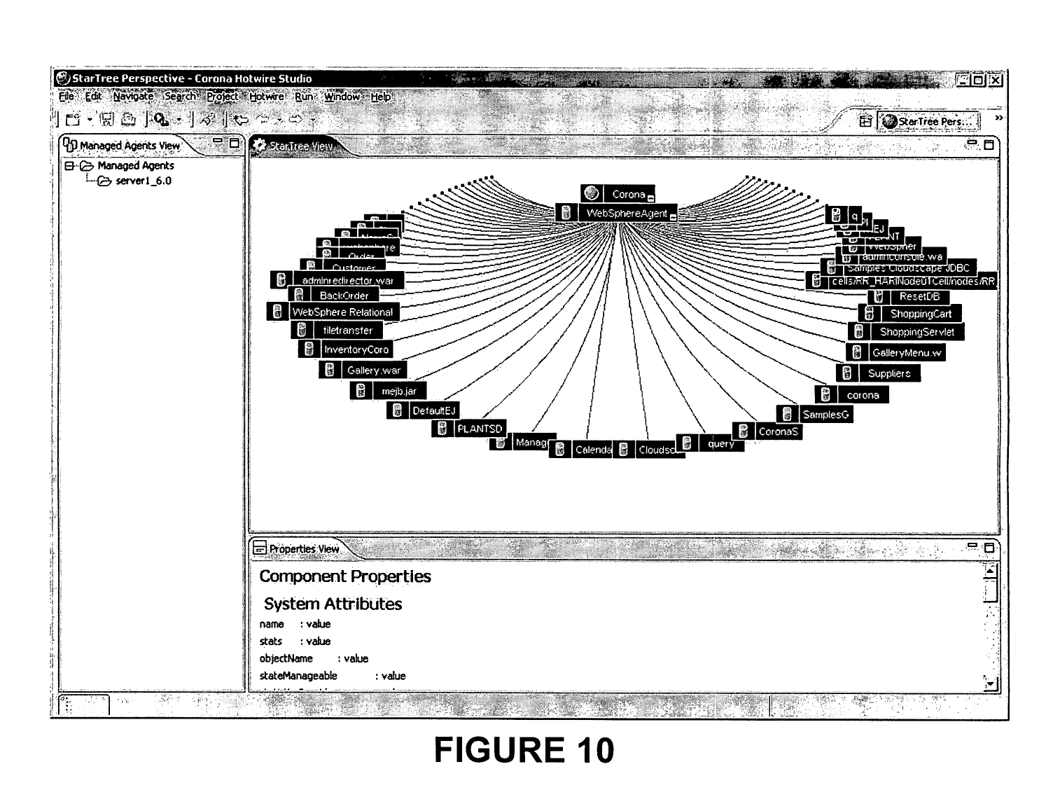

The hotwiring studio enables a user to match observations of interest defined in a model to behaviors exhibited by components. FIG. 10 shows an illustrative screen shot that depicts an agent and the components that it has discovered. Although one agent is shown in the illustrative example, more than one agent may be depicted. The left pane shows the illustrative agents that have been deployed across an enterprise or enterprises by the system. These agents discover all the components that are running on the “monitored” platform (monitored system). For the discovered components, the agents also discover behavior of the components. Behavior includes business attributes, system attributes and statistical information of the components. In the right pane, the hotwiring studio displays the discovered components and allows a user to select components of interest on which further operations can be performed including management, monitoring, instrumentation of the components and their behavior.

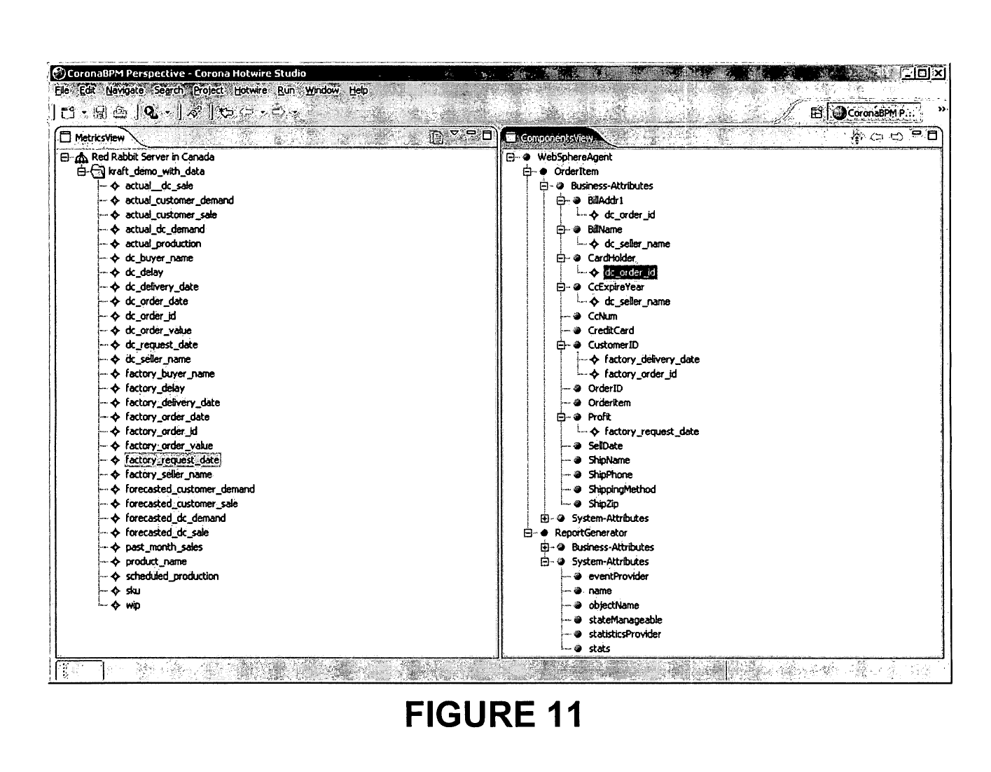

FIG. 11 shows another illustrative screen shot that depicts matching observations of interest defined in a model to behaviors exhibited by components. The left pane shows the model that captured the business issues. The right pane shows components that the user is interested in along with the behaviors of the component. The end user here can drag and drop the observations of interest defined in the model onto the behaviors exhibited by the components. Metrics are associated with attributes. The user can then publish this map back to the agent. The agent can then monitor, manage, and instrument the component and the specific attributes and send out atomic metrics in a defined format to the system and to any other external system that may be interested in that observation.

As business process orchestration happens in real time, the system platform hotwires live data into the published model from the business domain modeler. This allows for real time enterprise information integration. Independent of the business domain model and the hot wiring of real time data, reports of interest can be specified and designed. Such reports are available in real time to allow businesses to understand what is going on within their business domain and how to improve their business processes continuously.

Templates may be generated for particular scenarios making it an easy task to customize the events, metrics, and reports of interest for an enterprise. The customization and hot wiring of data into the templates will depend on systems that support process orchestration. Enterprises stand to gain, for example, by making ROI predictions much more accurate as well as ensuring corporate performance is well understood. In addition, business processes that may have been misinterpreted prior to modeling may be understood, because the business domain modeler provides a way to define domain models independent of what an enterprise has for its information technology systems or process capturing tools. Coupled with a strong methodology to support modeling the business domain, integrating the information flow and management of the enterprise artifacts, enterprises will be able to develop an understanding of their domain in ways that were not possible with conventional approaches.

A set of traditional and nontraditional business measurements—such as judging product and service quality, rating customer relationships, and measuring employee satisfaction and commitment—that are seen as critical for improving a company's bottom line can be modeled and viewed as a set of business performance metrics and sales metrics. This model can be used for a variety of purposes, such as supporting a balanced scorecard approach for setting goals and measuring performance, or for cause and effect.

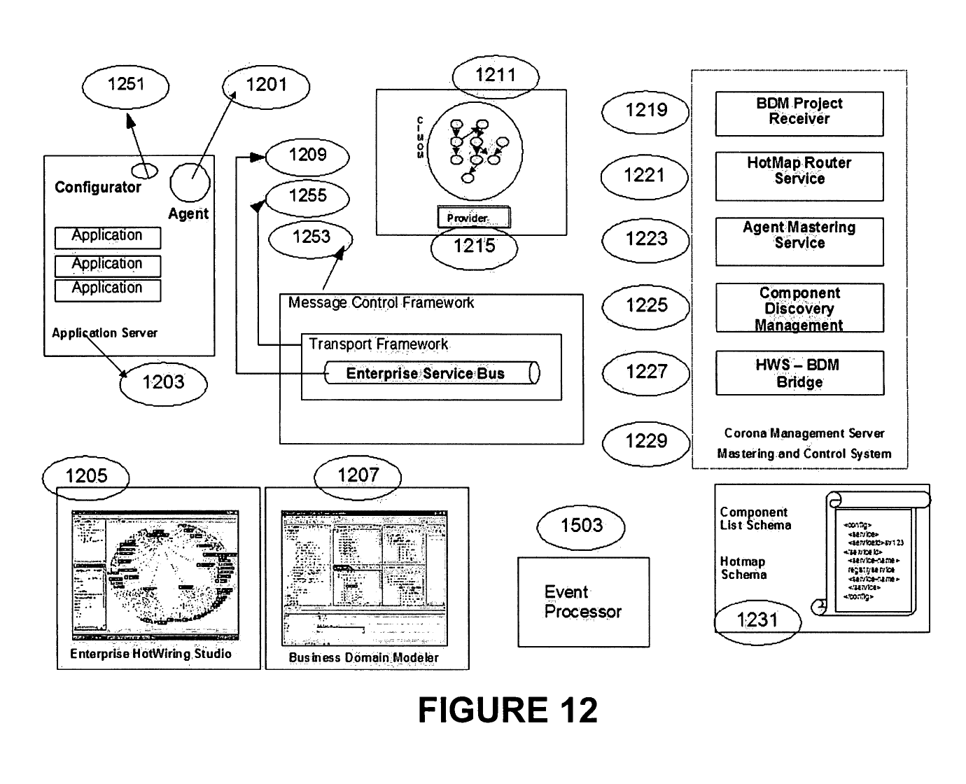

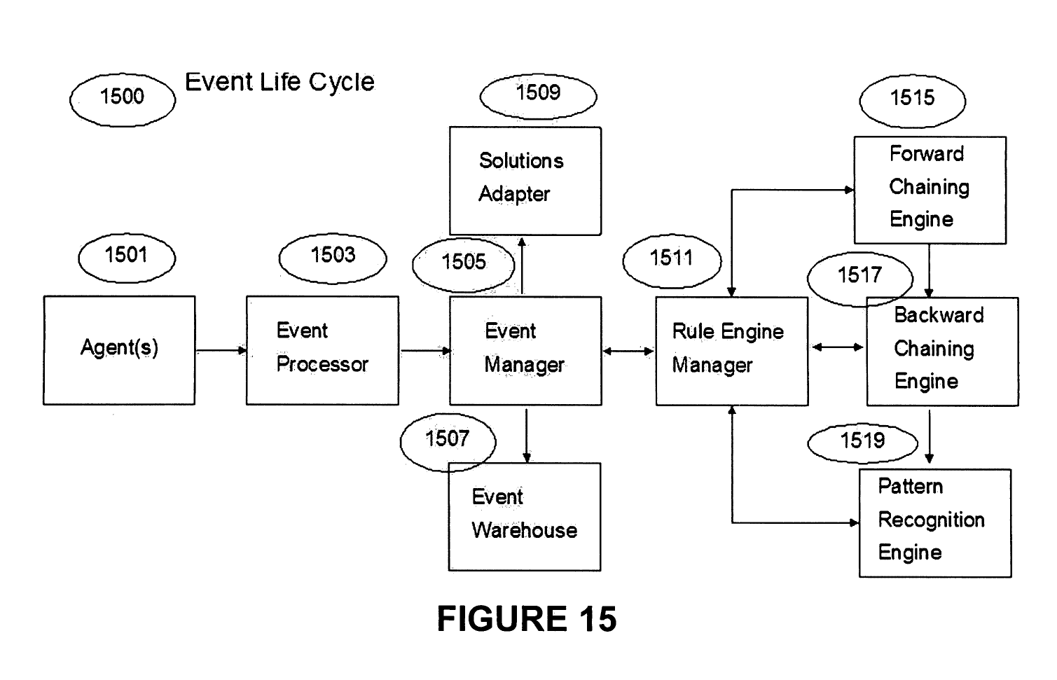

FIG. 12 is a block diagram of illustrative components of the system including sub-components of the mastering and control framework 1011. One or more agents 1201 are deployed, for example, on an application server 1203. Agents are configured via an agent configurator 1251. The agents communicate with other components via a network, such as an enterprise service bus 1209. Messaging and transport mechanisms are provided by a message control framework 1253 and a transport framework 1255. The agent sends observations to a mastering and control system 1229 and may send observations to a CIMOM module 1211 at a provider 1215. The mastering and control system may comprise a business domain module project receiver 1219, a hotmap router service 1221, an agent mastering service 1223, a component discovery manager 1225, and a hotwire studio to business domain modeler bridge 1227. The system also maintains a hotmap 1231 that identifies components to observe. As described above, business domain models may be modeled using a business domain modeler 1207 and hotwiring may be implemented using a hotwiring studio 1205. The agents may also send information to an event processor 1503 (see FIG. 15).

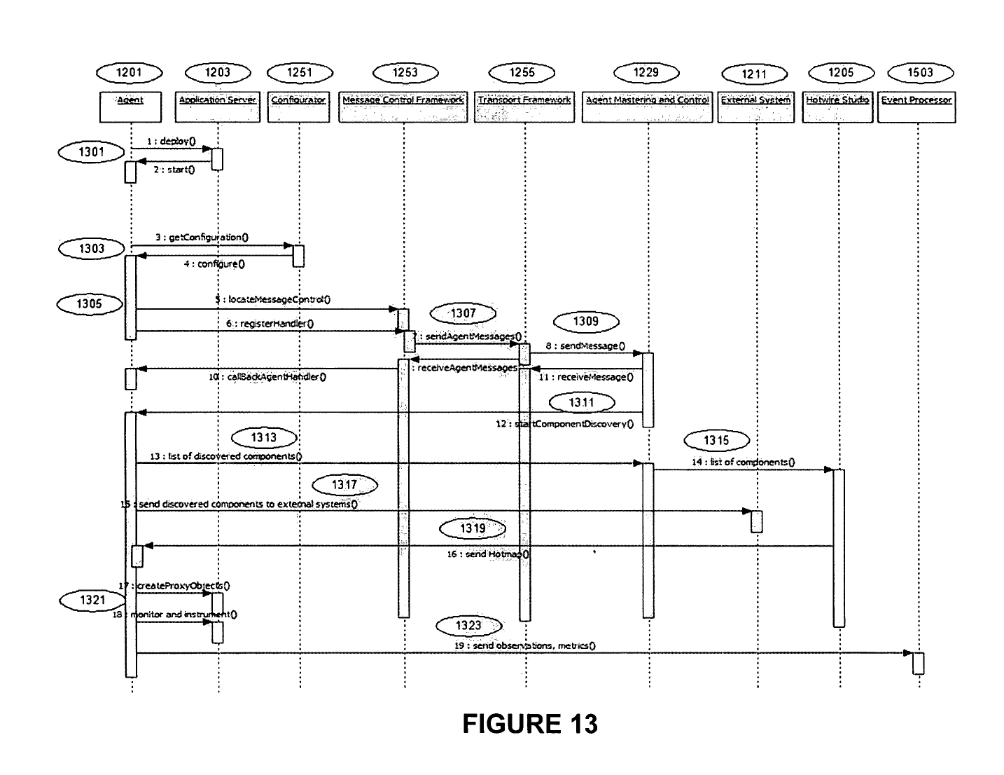

FIG. 13 is a sequence diagram that shows illustrative steps for deploying an agent. The sequence steps are described with reference to the components identified in FIG. 12. First, the agent 1201 is deployed on an application server 1203 or another type of platform (step 1301). The agent contacts the agent configurator so that the agent may be configured (step 1303). Then, the agent contacts the mastering and control framework 1229, for example, using a predefined topic (step 1305). In the illustrative example, the agent's message to the mastering and control framework is via a message control framework (step 1307) and transport framework (step 1309). The topic may be defined, for example, in a configuration file. This allows the mastering and control framework to have a map of the deployed agents.

In the illustrative example, the deployed agent is configured to listen on a topic for control messages. One having skill in the art will appreciate that the messages described herein are illustrative and that additional and alternative messages may be sent. When the agent receives a control message to start component discovery, it proceeds to discover the components (step 1311). Discovered components are stored on the agent and may be configured, for example, to the XML schema. A file (e.g., an XML file) that contains the discovered components is routed to the mastering and control framework from the agent via a topic (step 1313) and to the hotwire studio (step 1315). The agent may also send the discovered components as object messages to one or more external systems that may be in external formats, such as a Common Information Model (CIMOM) provider 1215 (step 1317).

Components that are selected on the hotwiring studio for hotwiring are sent as a file (hotmap) to the agent from the hotwire studio HWS 1227, via a corona service (step 1319). The agent receives the hotmap file and proceeds to create proxy objects for the components that are to be instrumented (step 1321). It determines whether proxy objects for those components already exist and creates the proxy objects if they do not exist. Attributes that need to be set for monitoring are on the proxy objects. Then, the agent can send out atomic metrics based on the instrumentation of the underlying component that is being monitored. The agent may also send observations and metrics to the event processor (step 1323).

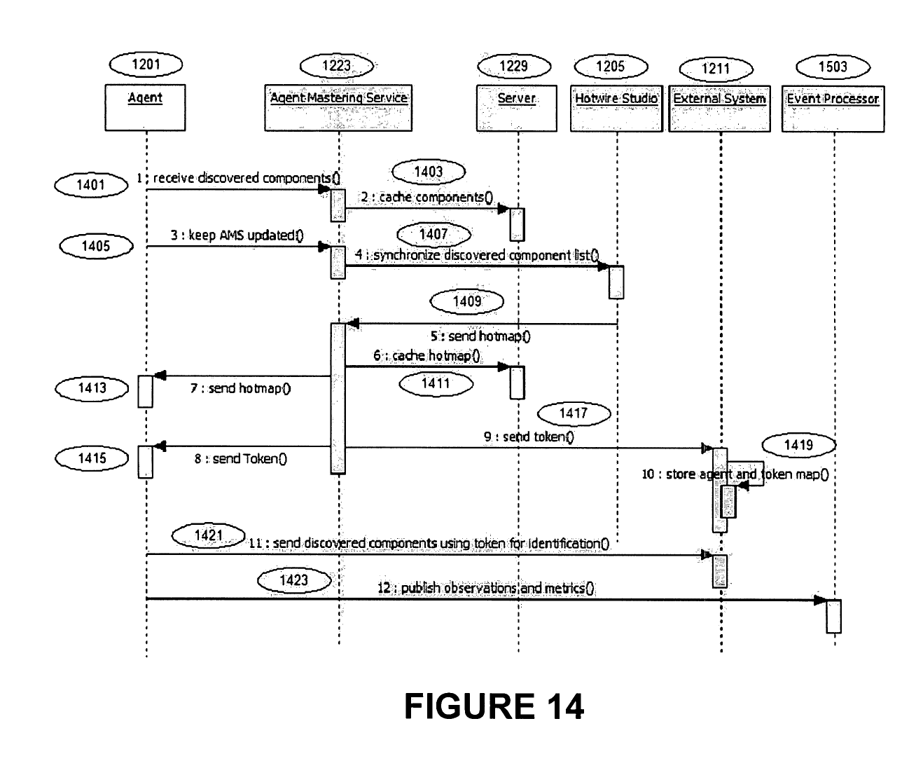

FIG. 14 is a sequence diagram showing illustrative steps for the mastering and control system. The mastering and control system manages agents as well as external systems, such as CIMOM providers. The mastering and control system receives maps of discovered components, such as XML or other types of map files, from agents and keeps a cache (step 1401). The files may be stored in memory or in secondary storage. In turn, the mastering and control system forwards the discovered components to the server (step 1403). If a map file changes, the respective agent sends a new map file, which is received by the mastering and control system. (step 1405). The mastering and control system sends the map files to the hotwire studio to keep the hotwire studio in synchronization (step 1407). When the hotwire studio sends hotmaps (step 1409), the mastering and control system caches them to the server (step 1411) and forwards them to the respective agent (step 1413).

The mastering and control system also implements a token system between the agent and the external system, such as a CIMOM provider, so that authorized agents (step 1415) and external system communicate (step 1417). The details of the token system implementation are within the mastering and control system service. The agent keeps the token it is sent and sets that in the header and uses that in communications with the external system. The external system keeps a map of tokens to appropriate agents, since multiple agents may communicate with one provider (step 1419). The external system sets the header, such as a JMS or other type of header that is based on the messaging protocol, with the appropriate token based on the agent for which the message is intended. The agent forwards discovered components to the external system using the token for identification (step 1421). Further, the agent may publish observations and metrics to the event processor (step 1423).

The agent mastering service broadcasts a request message for agents to respond with their unique Agent IDs. Upon receipt of an agent's identification response, the agent mastering service assigns a token to the agent and sends the token to the agent for communication with external systems. The agent master service also sends an updated agent/token map to external systems. The agent master service sends a heartbeat request message to each agent in a configurable time frame. If an agent does not respond over a configurable amount of time, the agent will be marked as dead by the agent mastering service.

The component discovery manager reads the cached discovered component lists for agents. The component discovery manager also makes method calls on the agent mastering service to instruct the agent mastering service to request agents to send their current component lists to the component discovery manager. The component discovery manager waits for requests from the hotwire studio for component lists for a specific agent or for all agents and responds by sending the component lists to the hotwire studio.

The hotwire router component provides cached hotmaps to agents. The hotwire router waits for requests from the hotwire studio asking for the current hotmap for an agent. It responds by sending the hotmap for that agent. The hotwire router may also wait for updated hotmaps to be sent by a hotwire studio. The hotwire router saves the updated hotmap and forwards the map on to the appropriate agent.

If the hotwire studio determines that it has a cache of files that identify components, it syncs with the mastering and control system to see if the files have changed. It displays the latest component list on the star tree. If hotwire studio is disconnected from the network, it may still display the tree from the cache of files. Based on a user selecting components for hotwiring, the hotwire studio will create a hotmap for a particular agent. Upon publishing the hotmap, the hotwire studio sends the hotmap files to the mastering and control system which forwards them on to the appropriate agent.

The system may hotwire instrument system attributes, business attributes, and statistics. The technique of proxy creation and instrumenting will vary from application server to application server. What is automated and what cannot be will also vary. There will also be a dependence on the particular component (e.g., EJB, servlet, web service, mainframe procedure, COM object, NET object, J2EE, and the like) as to the technique of instrumentation and management. In such cases, the agent may have multiple parts and to deal with different techniques it may have to employ for different components.

There may be multiple agents deployed on various heterogeneous platforms. These agents may have discovered components and behaviors and made that information available to the system. A user has also modeled the business issues and represented the issues via a business domain model. The model has been hotwired to specific observations and hotmaps, which map observations for a model to behaviors of discovered components, are deployed to the agents. The agents start monitoring the components that have been discovered. Agents can also be used to manage the discovered components. The agents instrument component behavior and, based on the hotmap provided to the agent, the agents send out the observations they make in the form of atomic metrics.

FIG. 15 is a functional block diagram that shows illustrative component interactions for event creation and management. An agent 1501 sends atomic metrics to an event processor 1503. A suitable transport mechanism may be used to send the atomic metrics. The illustrative system includes a transport framework for transporting the messages. The format of the atomic metrics is also flexible. The system may include adapters to facilitate utilizing data of different formats.

The atomic metrics are processed by the event processor, which outputs composite business events. These events are then managed by the event manager 1505. As part of the management, the event manager stores the events in an event warehouse 1507 for historical purposes. The events may be sent to another internal or external system for consumption and further processing. The event manager sends events to a rule engine manager 1511, which may apply business rules to the events. To apply rules to the events, the rule engine manager forwards the event to one or more of a forward chaining rule engine 1515, a backward chaining rule engine 1517, or a pattern recognition rule engine 1519. The event manager may also send events to a solutions adapter 1509, which may map events to industry-specific formats, to database schema, and to industry solutions. For example, events may be mapped to the National Retail Foundation (NRF) or Association for Retail Technology Standards (ARTS) format.

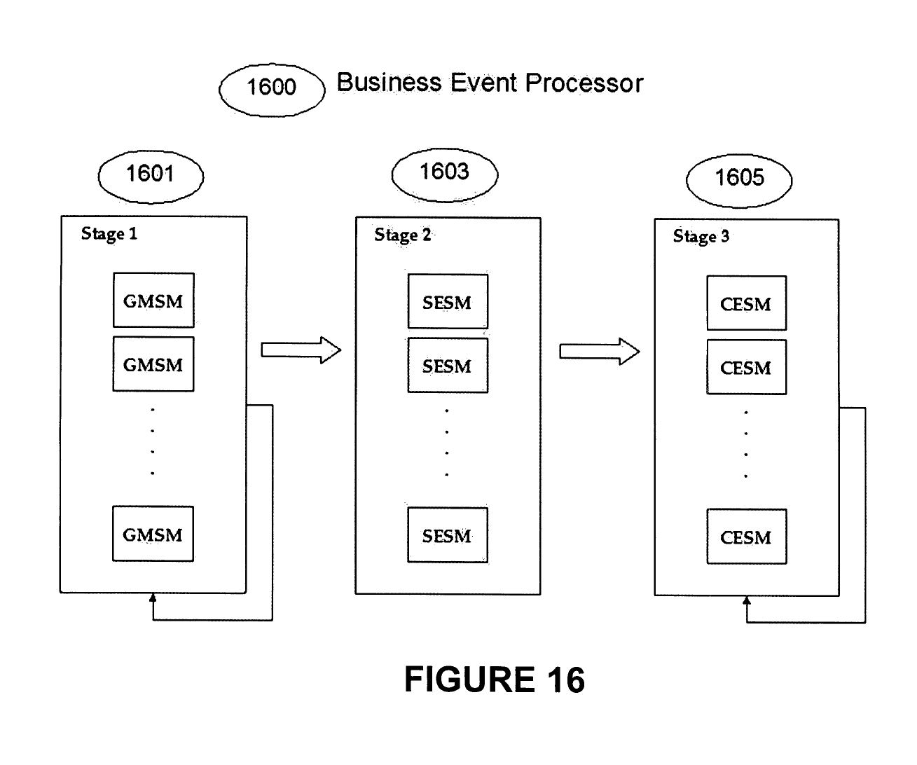

FIG. 16 shows a business event processor 1600 in more detail. The business event processor includes one or more processing stages for processing atomic metrics. The output of a stage may be fed back into the same stage and/or received by another stage. In the illustrative example, the event processor includes three stages 1601, 1603, and 1605. The event processor processes streams of information coming into it and generates business events. The streams of information come from one or more agents. The agent annotates the information stream and breaks up the information stream into atomic logical units called atomic metrics. The information streams can originate from multi-computer systems, multi-CPU systems, and other sources. Further, while the description herein is given in terms of atomic metrics, the IDs and annotations may be applied to other information units like atomic metrics, group metrics, simple events, composite events, and the like.

In the illustrative example, the annotation is applied to each atomic metric and may include, for example, the following:
Source ID: The source ID identifies the origin of the atomic metric.
Agent ID: A unique ID representing who created the information stream. A source may have one or more agents.
Stream ID: Each agent can create one or more streams of information and each stream has a unique ID.
Correlation ID: This is a virtual identifier that an agent can use to annotate atomic metrics that are related in some fashion. This may be determined by the agent. Related atomic metrics may have the same correlation ID.
Application ID: Application ID uniquely identifies an application running in memory within a component data processing system. The agent that is monitoring an application is provided with the unique application ID to that the Application ID will not change even if the application is stopped and started again to ensure consistency with past information units (atomic metrics) that were annotated with the application ID.
Session ID: The session ID is created based on an application session or user session. A session may live for a certain amount of time in the context of an interaction between two systems or between a user and a system. For example, suppose a user fills in the first page of a form, submits it and then fills in the second page of the form. Both forms will belong to the same session and can therefore be related by the Session ID issued to the user for that set of interactions. If the user does not submit the second form for a long time, depending on the implementation, the session expires. Accordingly, the user may once again fill in the first form and second form since the data has been lost on account of session expiry. To eliminate issues associated with disconnected information, Session ID may be used to relate information coming from the same session. In another example of using a Session ID, a user uses their e-mail service for ten minutes and then logs off. This is Session 1. Then if the user uses the e-mail service again later, it is regarded as another session and so on.
Transaction ID: Transaction ID uniquely identifies the activities and tasks that collectively relate and that are interpreted collectively. A transaction may span multiple applications, multiple sessions, and multiple information streams and agents. A transaction can also be long-lived and can last hours, days or longer. For example, when someone moves money from a savings account to a checking account, first money is subtracted from the savings account, then the checking account is updated with exactly the amount that was subtracted from savings. If the system fails after the first step, then the state of this transaction may be lost and the bank balance may become affected since money has been subtracted from the savings account but not yet added to the checking account, and the system failed thus losing its state. In this case, the transaction will be rolled back to ensure that money is not subtracted from the savings account.
Object ID (Instance ID): Instance ID is unique for each metric. This ID will be generated for the atomic metrics by the agent.
Timestamp: Each information unit is annotated with the timestamp of its creation.
Time zone: Represents the time zone in which the information was created.
Globally unique ID (GUID): Each metric may belong to a certain class of metric and may have a globally unique identifier to show which class the object is an instance of.

Besides these annotations, each metric may have other information, parameters, name, value, descriptions, and the like, to describe its contents.

The above-described illustrative annotations may be grouped, for example, into identifiers that qualify the observation with how the observation occurred, when it occurred, and where it occurred. These qualified observations allow observations to be correlated based on one or more of their respective qualifications. For example, a number of observations may be correlated based on where they occurred (source ID, agent ID, stream ID, and the like) when they occurred (timestamp, time zone, and the like) and/or how they occurred (transaction ID, application ID, session ID, and the like.) Unlike conventional approaches that fail to correlate observations based on how they occur, methods, systems, and articles of manufacture consistent with the present invention obtain observations from components in the functional, technical, and infrastructure architecture layers, which enables correlations based on how, where, and when these observations occurred. Further, other qualifiers, such as the illustrative correlation ID, may be used to correlate observations.

In the illustrative example, the event processor correlates related atomic metrics and creates group metrics and nested group metrics in the first stage, which is referred to herein as the Group Metric Source Manager (GMSM). A group metric is a grouping of related atomic metrics. Atomic metrics and group metrics may also be nested to create nested group metrics. Further, simple events and composite events may also be nested to create nested composite events. The event processor correlates related group metrics and creates simple events in the second stage, which is illustratively referred to herein as the Simple Event Source Manager (SESM). The event processor correlates related simple events and creates composite events in the third stage, which is illustratively referred to herein as the Composite Event Source Manager (CESM).

Each stage can be scaled independently and also distributed to run on another processing unit. Also there can be more than one instance of the same stage. The three-stage implementation is merely illustrative and there is no limit to the number of stages, number of information streams, how to distribute each stage, or how many instances of each stage that may be implemented in the system. The events themselves may exist for varying amounts of time. For example, events may be short-lived, long-lived, may exist until they are consumed for a defined number of times, or until a defined time expires, and the like.

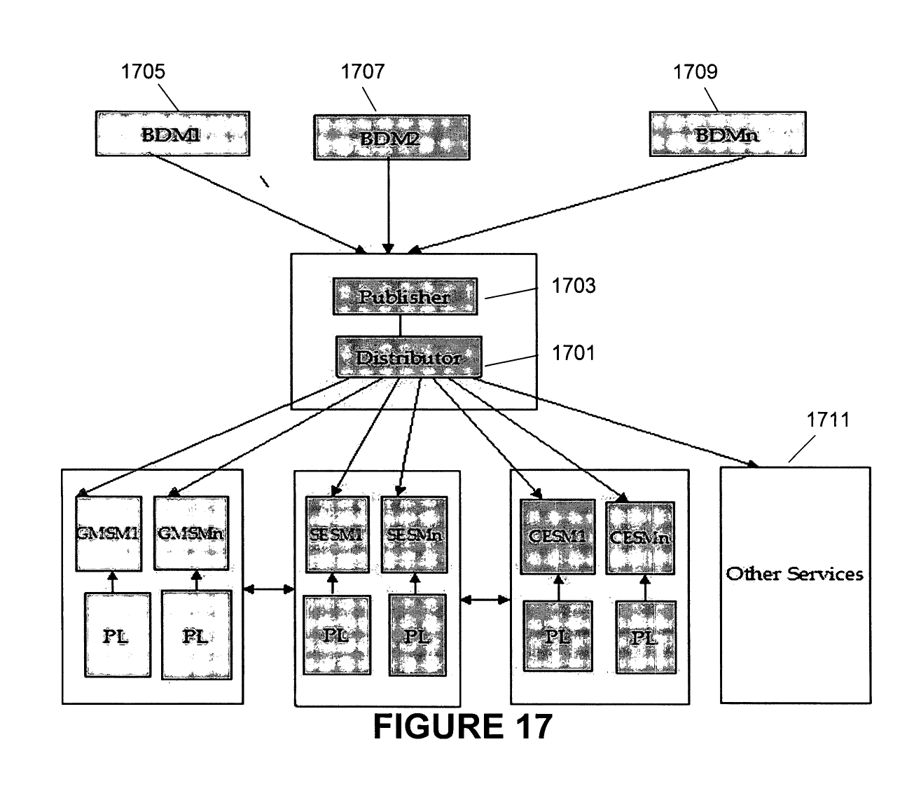

The information stream that is processed in each stage can itself be sent to other systems that are interested in the intermediate processing. As shown in FIG. 17, for example, the data streams may be sent to distributors 1701, publishers 1703, and replicators 1705, 1707, 1709 for accomplishing tasks like distributing, publishing, or replicating the streams. The data streams may also be send to other types of services 1711.

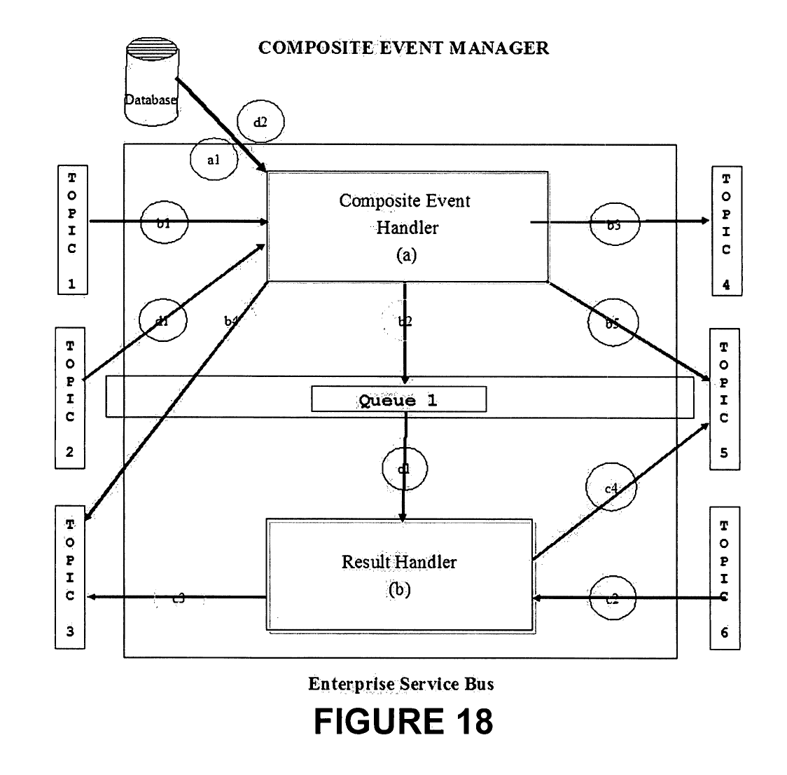

FIG. 18 depicts a composite event manager in more detail. The event manager comprises a composite event handler and a result handler. The composite event handler processes business events created by the event processor and checks whether there are any rules associated with the business events. Processing the composite event may include archiving the composite events into the event warehouse, publishing the events to external systems, sending the events to a solutions adapter for further processing, and interacting with the rule engine manager to apply rules to the events.

The composite event is checked for the existence of associated rules and if one or more rules exist, the event is passed on to the rule engine manager for rule execution. The result handler waits for the result of the rule execution from the rule engine manager. The rule engine manger itself may execute a set of rules on an event, in case there is more than one rule. The set of rules may be referred to as a rule set.

Upon receiving the result of rule execution, the result is updated to the event warehouse as well as other systems that are interested. The execution of the rule (or rule set) could be, for example, a pass or a fail. Pass indicates that the conditions of the rule were met and a fail indicates that the conditions of the rule were not met.

The result of the rule execution is published and can be used by another system (internal or external) for further processing. Also if there are no rules in the event, by default the event is said to be successful and is published, for example, to the topic. If there are any alerts attached to the event, the alert is sent to an alert service (through one or more protocols, for example—e-mail, JMS, or JMX) depending on the configuration of the specific alert. In the illustrative example, the communication semantics use topics and queues for communication between various components of the system.

The event manager and its constituent components may scale in any manner (similar to the multi-stage event processor). Further, they may be distributed and started as a service by the kernel. Each of these and other components described herein may be accessible via a user interface that may be called, for example, via an API, a GUI-based browser, and the like.

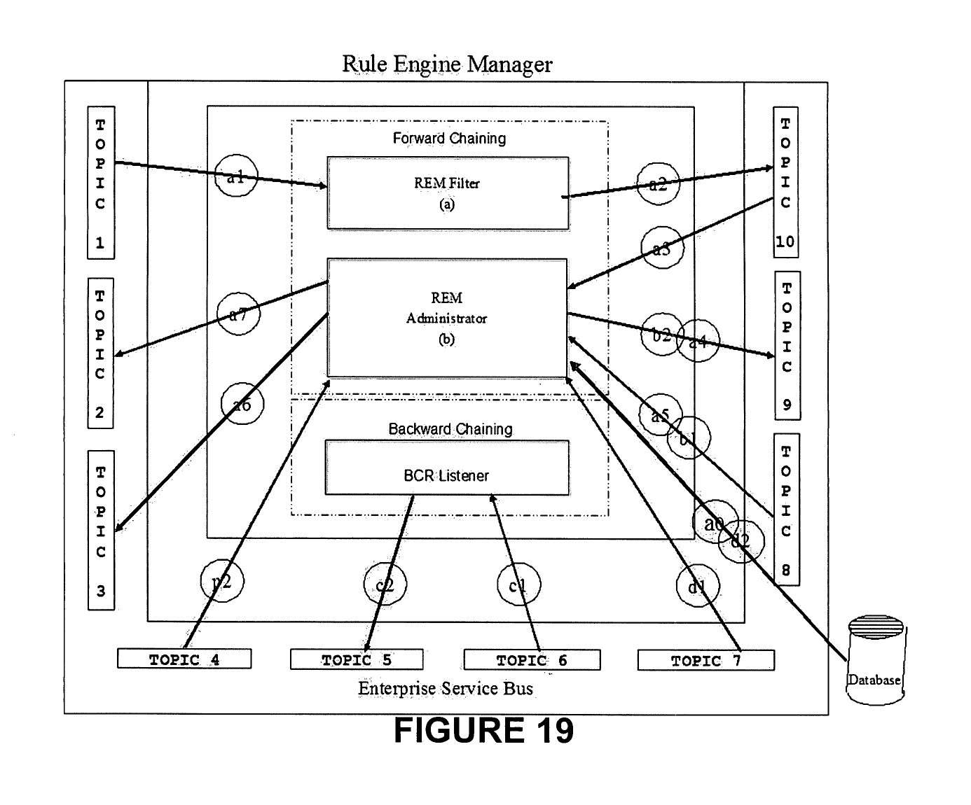

FIG. 19 depicts a rule engine manager in more detail. The rule engine manager provides forward chaining rule execution, backward chaining, and pattern recognition to components of the system. Forward chaining involves firing a business rule upon the occurrence of a business event. Conditions may need to be met while applying the rule to the event. The data for the conditions could come from information contained within the event itself or from outside. Multiple rules could be applied to a single event. This set of rules may be referred to as a rule set. In the forward chaining context, the rule engine manager is used to manage one or more rule engines (forward chaining) and execute rules upon the occurrence of events which are handed to the rule engine by the event manager. The rule engines may be third-party engines and if there are multiple rule engines, each of them could be different.

The rule engine manager comprises an event filter and an administrator. The event filter receives the composite events from the event manager and filters the simple events that do not contain rules and the nested composite events that do not contain simple events. The administrator provides administration functionality, including but not limited to subscription/deletion of rule engines to/from the rule engine registry.

Once events are filtered, the rules and data are extracted and each rule is sent to a free (idle) rule engine for rule execution. In an illustrative example, all the rules in a rule set have to PASS in order for the composite event to receive a PASS. Alternatively, the rule may implement criteria such that all the rules do not have to PASS. Once the rules have been executed, the result is sent back to the event manager.

The rule engine manager awaits the results from a rule engine, and upon reception of results of firing all the rules (if there is more than one rule in a rule set) for a particular event, the final result is sent to the composite event manager with the information that indicates whether the composite event has PASSED or FAILED.

On reception of a subscription request from a rule engine, a unique ID (GUID) is generated which identifies the rule engine uniquely for the life span of the application. This GUID is inserted into a map so that existing rule engines may be tracked and utilized to fire rules. This GUID is then sent to the requested rule engine as an acknowledgment. Upon reception of drop requests from an already-registered rule engine, the rule engine manager removes the entry for the requested rule engine from the map.

Backward chaining involves applying queries to already collected information sets, which are referred to herein as knowledge bases. Backward chaining may include inferring certain results from the collected information or asking queries and retrieving information that match the query from the information base. In the backward chaining context, the rule engine manager may manage one or more backward chaining rule engines. The rule engines can be third-party engines and if there are multiple rule engines, each of them could be different.

Pattern recognition involves the system making an inference without the use of external queries.

Thus, methods, systems, and articles of manufacture consistent with the present invention manage business issues by modeling the business issues and domain semantics in real time. After the business issues are modelled, the functional and the underlying technical components that are responsible for fulfilling the business process execution are located and identified automatically. Specific behaviours of those components are intercepted to determine what transpires within those components so that the information can be related back to the business issues. Accordingly, business issues are analyzed in real-time with current data that is automatically extracted from the underlying hardware and software systems.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A computer-implemented method in a data processing system having a program for creating a business domain model, the method comprising the steps of:
identifying an observation that influences a business issue;
identifying an event that corresponds to the observation;
implementing a rule that may generate an output responsive to the event; and
applying the rule to the event.

2. The method of claim 1, wherein the step of identifying the observation comprises the steps of:
receiving a plurality of observations at an event processor, each observation having at least one qualifier;
correlating at least two of the observations based on their qualifiers; and
associating the correlated observations to the business domain model.

3. The method of claim 2, wherein the step of identifying the event further comprises the step of:
aggregating the correlated observations.

4. The method of claim 3, wherein the correlated observations may be aggregated at least one time.

5. The method of claim 3, wherein the step of implementing the rule further comprises the step of:
applying at least one rule when aggregating the correlated observations.

6. The method of claim 1, wherein the rule is applied to the event using forward chaining.

7. The method of claim 1, further comprising the step of:
applying a query to a plurality of historically collected events.

8. The method of claim 1, further comprising the step of:
publishing the business domain model such that it may be used to automatically address a business issue.

9. The method of claim 1, further comprising the steps of:
automatically identifying a component that can provide the observation.

10. The method of claim 9, wherein the component is automatically identified using a software agent.

11. The method of claim 10, further comprising the step of:
identifying a behavior of the component that the software agent is to observe.

12. The method of claim 11, further comprising the step of:
associating the identified component and behavior with an aspect of the business domain model.

13. The method of claim 10, wherein the software agent obtains the observation and forwards the observation.

14. The method of claim 1, wherein a firing of the rule may have a consequence within the data processing system

15. The method of claim 1, wherein the firing of the rule may have a consequence outside of the data processing system.

16. The method of claim 1, further comprising the steps of:
the event processor outputting at least one event and a rule set that corresponds to the at least one event.

17. The method of claim 2, wherein the event processor may consider additional information when correlating the observations.

18. The method of claim 1, wherein the step of applying the rule to the event comprises:
computing the rule using at least one of the event and external data as an input.

19. The method of claim 1, wherein the rule is applied using a rule engine that receives the rule and the event as inputs.

20. The method of claim 1, further comprising the step of:
displaying an influence on the business issue based on at least one observation.

21. A computer-readable medium containing instructions that cause a program to perform a computer-implemented method for creating a business domain model, the method comprising the steps of:
identifying an observation that influences a business issue;
identifying an event that corresponds to the observation;
implementing a rule that may generate an output responsive to the event; and
applying the rule to the event.

22. A data processing system comprising:
a memory having a computer-implemented program performs a method for creating a business domain model that identifies an observation that influences a business issue, identifies an event that corresponds to the observation, implements a rule that may generate an output responsive to the event, and applies the rule to the event; and
a processing unit that runs the program.
